(19) United States
(12) Patent Application Publication
(10) Pub. No.: US 2023/0189303 A1
(43) Pub. Date: Jun. 15, 2023

(54) ENHANCEMENTS TO NR SIDELINK RESOURCE SELECTION ASSISTANCE SCHEMES

(71) Applicant: Samsung Electronics Co., Ltd., Suwon-si (KR)

(72) Inventors: Yaser Mohamed Mostafa Kamal FOUAD, San Diego, CA (US); Philippe Jean Marc Michel SARTORI, Naperville, IL (US); Mohammed KARMOOSE, San Diego, CA (US); Jung Hyun BAE, San Diego, CA (US)

(21) Appl. No.: 18/079,763

(22) Filed: Dec. 12, 2022

Related U.S. Application Data
(60) Provisional application No. 63/289,391, filed on Dec. 14, 2021.
(60) Provisional application No. 63/305,371, filed on Feb. 1, 2022.

(51) Int. Cl. H04W 72/40; H04W 72/04; H04W 72/25

(52) U.S. Cl. CPC H04W 72/40; H04W 72/04; H04W 72/25

(57) ABSTRACT

A system and a method are disclosed for improving resource selection schemes is provided. In an embodiment, Scheme 2 resource selection is improved by using a Sidelink Feedback Channel (PSFCH) resources to identify specific instances of conflicts in a periodic reservation of a resource. In an embodiment, Scheme 1 resource selection is improved by allowing a user equipment (UE) to include non-preferred resources in a candidate resource set based on one or more conditions and/or subject to one or more limitations. In an embodiment, condition triggered resource selection assistance is improved by restricting a UE from sending resource selection assistance information unless a second condition is satisfied.

### CROSS-REFERENCE TO RELATED APPLICATION

This application claims the priority benefit under 35 U.S.C. § 119(e) of U.S. Provisional Application No. 63/289,391, filed on Dec. 14, 2021, and U.S. Provisional Application No. 63/305,371, filed on Feb. 1, 2022, the disclosures of both of which are incorporated by reference in their entirety as if fully set forth herein.

### TECHNICAL FIELD

The disclosure generally relates to new radio (NR) sidelink communications. More particularly, the subject matter disclosed herein relates to improvements to Scheme 1 and Scheme 2 resource selection assistance.

### SUMMARY

The following is a list of acronyms used in this disclosure and their respective definitions:

| Abbreviation | Definition |
|---|---|
| SL | Sidelink |
| NR | New Radio |
| UE | User Equipment |
| ACK/NACK | Acknowledgement/Negative Acknowledgement |
| Tx UE | Transmitting User Equipment |
| Rx UE | Receiving User Equipment |
| gNB | Base Station (gNodeB) |
| SCI | Sidelink Control Information |
| PUCCH | Sidelink Uplink Control Channel |
| CBR | Channel Busy Ratio |
| RSRP | Reference Signal Received Power |
| HARQ | Hybrid automatic repeat request |
| PSFCH | Sidelink Feedback Channel |
| V2X | Vehicle to Everything |

NR SL transmissions are becoming increasingly more common for applications that benefit from high throughput and reliability that is difficult to achieve using Long-Term Evolution (LTE) technology, such as advanced driving which utilizes wireless communications between different sensors of a vehicle or platooning of autonomous vehicles which utilizes wireless communications between the vehicles.

HARQ requires feedback from the receiver to the transmitter. In order to support this feedback, a new channel, the Physical Sidelink Feedback Channel (PSFCH) was introduced. The feedback is transmitted using the same format as PUCCH format 0, whereby sequences are used for transmitting the ACK/NACK. Using PUCCH format 0 for the PSFCH provides robustness since it ensures detection in challenging radio-conditions. However, it imposes a strict limit on the number of bits that can be carried by the PSFCH thus limiting its capacity: at the moment, for HARQ feedback, a UE can transmit a single sequence per PSFCH occasion to a given UE (note: a UE can transmit multiple PSFCHs at the same time, but not to the same UE), thus can convey a single bit of information. To further enhance the feedback channel, Resource selection assistance Scheme 2 was introduced in Rel-17. In this scheme, an additional Zadoff Chu (ZC) sequence is sent in PSFCH resources not used for ACK/NACK feedback to indicate the presence of a conflict and trigger the Tx UE to perform resource selection. Hence, when combined with the ACK/NACK feedback, up to two bits of information can be carried by the HARQ procedure and the Scheme 2 procedure introduced in Rel-17.

In NR SL Rel-17, a new resource selection assistance scheme was developed (i.e., Scheme 2) that uses PSFCH format 0 to signal the assistance information to the assisted UE. In particular, when a potential conflict is detected on a future reserved resource by the assisting UE (i.e., UE-A), it can send the conflict indication to the assisted UE (i.e., UE-B) over PSFCH resources. These PSFCH resources will be configured separately from those that are used for ACK/NACK feedback for legacy systems. Despite the advantages of this scheme, it offers limited amount of feedback information (i.e., currently limited only to conflict indication) and thus does not fully utilize the capabilities of the PSFCH channel.

The limited information in Scheme 2 resource selection assistance can create problems in cases of periodic reservations. In particular, if UE-B reserves a set of periodic resources and receives a conflict indication from UE-A, it can't clearly conclude whether the conflict occurs on the first instance only of the periodic reservation or following instances as well. In other words, it needs to know the instance over which the conflict occurs to react accordingly. Given this uncertainty, UE-B will be required to perform resource reselection for all the periodic reservations thus resulting in resource wastage when a periodic reservation is not being used by any UEs because it was previously reserved and higher chances of additional conflicts during resource reselection. Thus, there is a need for a method of providing additional information for periodic reservations during Scheme 2 resource selection.

In Scheme 1 resource selection, an assisting UE provides a list of non-preferred resources to an assisted UE. The assisted UE then generates a set of candidate resources and selects resources from the set for transmission. In the resource allocation procedure of TS38.214, a transmitting UE is required to have a set of a particular size from which to select resources. If the size of the set of candidate resources is smaller than the threshold, the next steps in the procedure is to reduce the sensitivity of sensing and retry. While this can increase the number of resources available in some instances, it does not increase the number of available resources when resources have been excluded due to assistance listing too many resources as non-preferred. In this instance, the assisted UE may become stuck in an infinite loop of reducing the sensitivity of sensing, generating a set of candidate resources which excludes the non-preferred resources, determining that the set is too small, and restarting with another reduction of the sensitivity of sensing. Thus, there is a need for a method for avoiding the infinite loop due to a large number of non-preferred resources.

The Scheme 1 resource selection additionally includes a procedure for the triggering of resource selection assistance based on surrounding conditions instead of from an explicit request from a UE. In particular, UE-A can be triggered by predefined conditions to follow Scheme 1 and send assistance information (i.e., either preferred or non-preferred resources) to its neighboring UEs. However, since this assistance is not requested by a neighboring UE, it might not be actually needed depending on how the conditions are defined. In addition, since triggering conditions can be sensed simultaneously by multiple UEs, it might result in multiple UEs simultaneously transmitting assistance information and subsequently, they might be very redundant and in extreme cases it might have a negative impact on the system due to a large number of inter-UE assistance messages occupying a significant number of resources for resource selection that could have been otherwise used to send data and an abundance of information creating confusion, such as when non-overlapping preferred sets are received from different UEs or when non-preferred sets from different UEs result in over-exclusion of resources. Thus, there is a need for a method of limiting criteria based resource selection assistance.

To overcome these issues, systems and methods are described herein for improving Scheme 2 and Scheme 1 resource selection assistance. For Scheme 2, a method is provided for signaling specific instances of a periodic reservation of a resource conflict with another reservation of the resource. Specifically, different cyclic shifts of a PSFCH resource are used to indicate where in the periodic reservation the conflict occurs, such as in only a first instance, in instances after the first, or in both the first instance and instances after the first.

For Scheme 1 resource selection assistance, a method is provided for generating sets of resources which incorporate one or more non-preferred resources. The non-preferred resources may be included with a penalization, such as an assumption that the resources are reserved by a different UE with a pre-set priority level. The non-preferred resources may additionally or alternatively be selected for inclusion based on one or more criteria.

For Scheme 1 resource selection assistance, a method is provided for reducing a number of resource selection assistance transmissions amongst UEs. An assisting UE initially detects a first criterion that triggers resource selection assistance. In response to detecting the first criterion, the UE evaluates a second criterion, such as whether a CBR is less than a threshold value or whether the number of reports received from neighboring UEs is below a threshold number.

The above approaches improve on previous methods by providing additional information to assisted UEs which can then better utilize resources for periodic reservations, increasing a pool of available resources for performing resource selection, and reducing a number of resource selection assistance messages.

In an embodiment, a method comprises receiving, at a first user equipment (UE) from a second UE, data identifying a periodic reservation of a resource; determining, at the first UE, that there is a conflict for the resource in at least one instance of a plurality of instances of the periodic reservation of the resource; and transmitting, from the first UE to the second UE, a PSFCH resource comprising a cyclic shift which indicates a strict subset of the plurality of instances of the periodic reservation that include the conflict for the resource.

In an embodiment, the strict subset of the plurality of instances consists of a first instance of the periodic reservation. In an embodiment, wherein the strict subset of the plurality of instances excludes the first instance of the periodic reservation.

In an embodiment, the method further comprises identifying, at the first UE, stored configuration data for a particular resource pool which indicates a type of information the first UE can provide and which cyclic shifts correspond to conflicts on different instances of the plurality of instances; and determining the cyclic shift based on the stored configuration data.

In an embodiment, a method comprises receiving, at a first user equipment (UE) from a second UE, resource selection assistance information which identifies a plurality of non-preferred resources; generating a set of candidate resources comprising one or more of the non-preferred resources; selecting a resource from the set of candidate resources comprising the one or more of the non-preferred resources for transmission.

In an embodiment, generating the set of candidate resources comprises including the one or more of the non-preferred resources with an assumption that the one or more of the non-preferred resources are reserved by a neighboring UE. In an embodiment, the assumption that the one or more of the non-preferred resources are reserved by a neighboring UE comprises a priority level for the assumed reservation that is pre-configured for a resource pool or type of transmission. In an embodiment, the assumption that the one or more of the non-preferred resources are reserved by a neighboring UE comprises an RSRP level for the assumed reservation that is pre-configured for a resource pool or type of transmission.

In an embodiment, generating the set of candidate resources comprising the one or more of the non-preferred resources comprises selecting non-preferred resources for inclusion based on one or more criteria. In an embodiment, the one or more criteria comprise whether the one or more of the non-preferred resources were indicated by a destination UE or the second UE. In an embodiment, the one or more criteria comprise whether the one or more of the non-preferred resources are listed as non-preferred due to a conflict or due to the second UE not performing listening for the one or more of the non-preferred resources.

In an embodiment, the method further comprises detecting, at the first UE, a triggering condition; and including the one or more of the non-preferred resources in the set of candidate resources in response to detecting the triggering condition. In an embodiment, the triggering condition comprises a determination that exclusion of all of the non-preferred resources would cause a remaining number of resources to be less than a threshold value or that a number of non-preferred resources is greater than a threshold value. In an embodiment, the method further comprises selecting one or more first resources from the non-preferred resources based on a first criterion; and determining, that the triggering condition would still be satisfied if the one or more first resources are not excluded and, in response, selecting one or more second resources from the non-preferred resources based on a second criterion; wherein the one or more of the non-preferred resources include the one or more first resources and the one or more second resources

In an embodiment, a method comprises detecting, at a first user equipment (UE), a triggering condition for resource selection assistance; in response to detecting the triggering the triggering condition, determining whether a second condition is satisfied; and transmitting, from the first UE to a second UE, resource selection assistance information in response to determining that the second condition is satisfied.

In an embodiment, the second condition comprises a channel busy ratio (CBR) being below a threshold value. In an embodiment, the method further comprises determining the threshold value based on a priority level of communications from the second UE. In an embodiment, the second condition comprises a number of assistances reports received from neighboring UEs within a particular period of time being less than a threshold number. In an embodiment, the first UE is configured to only determine that the second condition is satisfied prior to transmission of resource selection assistance information for groupcast or broadcast transmissions.

In an embodiment, a system comprises a first user equipment (UE) and a second UE; wherein the first UE is configured to send resource selection assistance information to the second UE which identifies a plurality of non-preferred resources; wherein the second UE is configured to generate a set of candidate resources comprising one or more of the non-preferred resources; and select a resource from the set of candidate resources comprising the one or more of the non-preferred resources for transmission. In an embodiment, the first UE is configured to detect a triggering condition for resource selection assistance; in response to detecting the triggering condition, determine whether a second condition is satisfied; and transmit the resource selection assistance information in response to determining that the second condition is satisfied.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating a communication system, according to an embodiment.

FIG. 2 depicts an example method of providing resource selection assistance using PSFCH resources.

FIG. 3 depicts an example method of excluding resources during resource selection based on provided assistance information.

FIG. 4 is a block diagram of an electronic device in a network environment, according to an embodiment.

FIG. 5 shows a system including a UE 505 and a gNB 510, in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or”includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

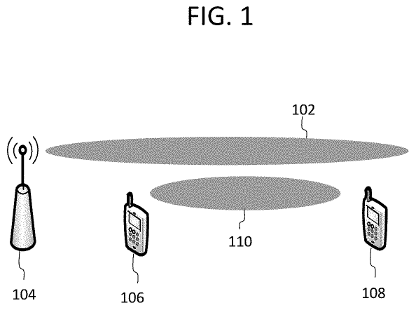

FIG. 1 is a diagram illustrating a communication system, according to an embodiment. In the architecture illustrated in FIG. 1, a control path 102 enables the transmission of control information through a network established between a gNB 104, a first UE 106, and a second UE 108. A data path 110 enables the transmission of data (and some control information) on an SL between the first UE 106 and the second UE 108. The control path 102 and the data path may be on the same frequency or may be on different frequencies.

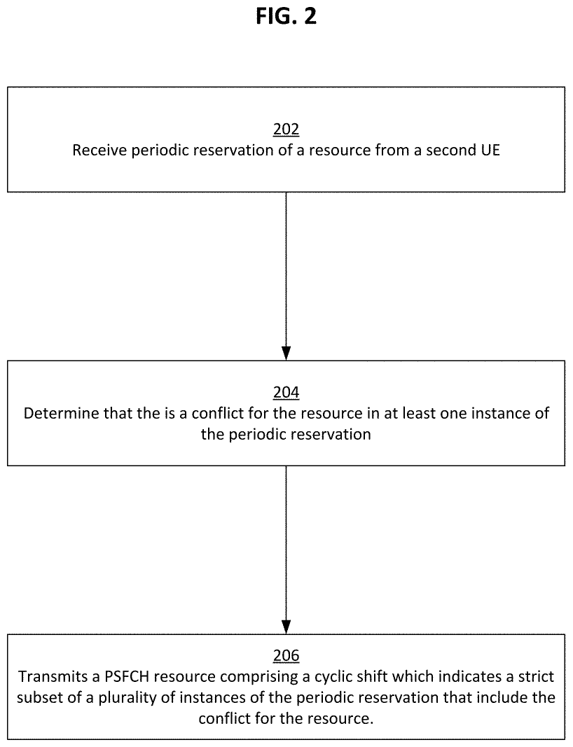

FIG. 2 depicts an example method of providing resource selection assistance using PSFCH resources. At step 202, a first UE receives data from a second UE which specifies a periodic reservation of a resource. For example, an assisting UE may receive a periodic resource reservation from an assisted UE in accordance with an NR SL Scheme 2 resource assistance scheme.

At step 204, the first UE determines that there is a conflict for the resource in at least one of a plurality of instances of the periodic reservation. For example, the assisting UE may store or access data identifying other reservations by other UEs. As a practical example, a third UE may have previously reserved the resource for a particular period of time. The assisting UE may determine that the periodic reservation for the resource from the assisted UE overlaps with at least a portion of the period of time of the reservation of the resource by the third UE. The assisting UE may further identify specific instances of the periodic reservation that overlap with a period of time of the reservation for the resource from another assisted UE. For instance, the assisting UE may determine that a reservation from another UE of the resource ends after a first instance of the periodic reservation but before a second instance of the periodic reservation, thereby only creating a conflict for the first instance of the reservation.

At step 206, the first UE transmits a PSFCH resource comprising a cyclic shift which indicates a strict subset of a plurality of instances of the periodic reservation that include the conflict for the resource. As an example, two cyclic shifts—such as cyclic 0 and cyclic 6—may be used to indicate whether the conflict exists only on the first instance of the periodic reservation (cyclic 0) or the first and subsequent instances of the periodic reservation. More advanced versions may utilize more cyclic shifts. For example, using three cyclic shifts, the first UE may indicate a conflict in only a first instance of the periodic reservation, a conflict in instances of the periodic reservation other than the first, or both in the first instance of the periodic reservation and in resources other than the first instance.

While examples above use indicators of the first instance of the periodic reservation or others, other examples may use the PSFCH resource to indicate conflicts in any of the instances of the periodic reservation, such as the second instance or third instance, and/or any combination of instances, such as in both the first and second instance but not in future instances.

When the second UE receives the PSFCH resource, the second UE may determine, based on the cyclic shift, which of the plurality of instance include the conflict for the resource. The second UE may then send an updated reservation that takes into account the conflict for the resource in the specific instance. For example, if the conflict only exists on the first instance of the periodic reservation, the second UE may reserve the resource for a periodic reservation starting after the time period corresponding to the first instance and use a different resource for the time period corresponding to the first instance of the periodic reservation. Thus, the second UE may select an alternative resource for the specific instance or instances that are conflicted but maintain the periodic reservation for the remaining instance of the periodic reservation.

In some embodiments, the cyclic shifts used to provide assistance and their corresponding conflict indications are configured per resource pool. Thus, the first UE may determine, based on configuration data, the type of information the first UE can provide and which cyclic shifts correspond to which types of conflicts.

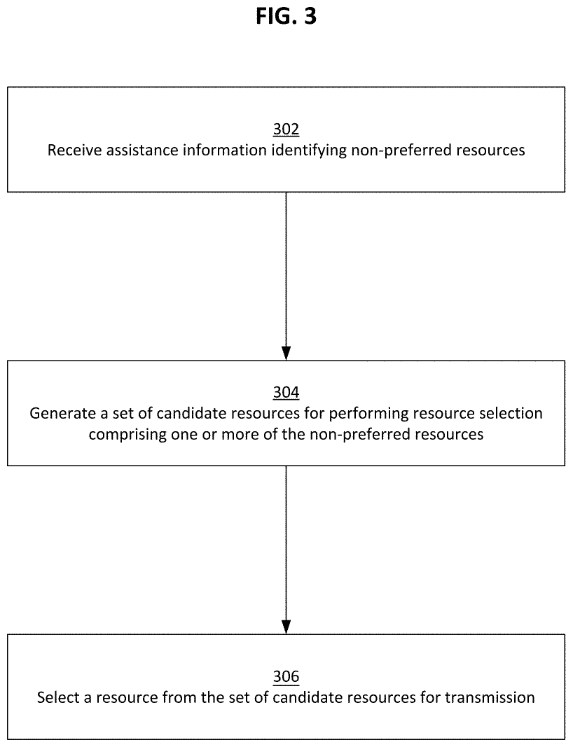

FIG. 3 depicts an example method of excluding resources during resource selection based on provided assistance information. At step 302, a first UE receives assistance information from a second UE which identifies non-preferred resources. For example, under NR Rel-17 SL Mode 2 resource selection, a transmitting UE sends a request to a receiving UE for Scheme 1-based assistance comprising a list of preferred or non-preferred resource sets. The receiving UE then generates a list of preferred or non-preferred resources based on information available to the second UE, such as conflict information indicating previous reservations of resources by other UEs.

In some embodiments, the second UE sends assistance information to the first UE without receiving an explicit request from the first UE. For example, the second UE may perform condition triggered resource selection assistance wherein the second UE provides assistance information to the first UE in response to detection of a condition other than a request from the first UE, such as two UEs reserving overlapping resources for their future transmissions. Note that their future reservations can be either periodic or aperiodic.

In some embodiments, when performing condition triggered resource selection assistance, the second UE is configured to only send resource assistance if a second condition is satisfied. For example, the second UE may receive or generate measurements of a relating to channel usage, such as a channel busy ratio (CBR). The second UE may be configured to only send the assistance information if the CBR is less than a threshold value, such as 50%. As another example, the second UE may determine whether a number of assistance reports received from neighboring UEs is below a threshold number, such as one, within a particular period of time.

An example implementation is as follows. An assisting UE initially detects a first condition, such as two UEs reserving overlapping resources for their future transmissions. In response to detecting the condition, the assisting UE determines whether a second condition is satisfied, such as whether a CBR is less than a threshold value or whether the number of reports received from neighboring UEs is below a threshold number. If the second condition is satisfied, the assisting UE provides the assistance information. If the second condition is not satisfied, the assisting UE does not provide the assistance information.

In some embodiments, the thresholds of the second condition are pre-configured for all UEs within a resource pool. In some embodiments, different thresholds are used for different priority levels. For example, a first threshold of 50% CBR may be configured for a first priority level while a second threshold of 75% CBR may be configured for a second priority level.

In some embodiments, the second condition is only evaluated for groupcast or broadcast assistance. Thus, if the assisting UE is performing condition triggered resource selection assistance for unicast transmission, the assisting UE may not evaluate the second condition and instead transmit the assistance information in response to detection of the first condition.

Referring again to FIG. 3, at step 304, the first UE generates a set of candidate resources comprising one or more of the non-preferred resources. For example, in some instances a first UE may be required to select resources from a resource candidate selection set that includes a threshold number of resources. If too many resources are excluded from the set due to the resources being listed as non-preferred, the first UE may not have more than a threshold number of resources. Thus, the first UE may be configured to generate a set that includes one or more of the resources identified as non-preferred.

In some embodiments, the first UE includes the one or more of the non-preferred resources with an assumption that the non-preferred resources are reserved by a neighboring UE. The assumed reservation may comprise a priority level that is pre-configured generally, for the resource pool, for a type of transmission, and/or for the first UE. The assumed reservation may additionally or alternatively include an RSRP level that is pre-configured generally, for the resource pool, for a type of transmission, and/or for the first UE. Due to the reservation assumption, the set from which the first UE selects a resource will comprise the non-preferred resources, but other resources will be prioritized in the resource selection.

In some embodiments, the first UE selects non-preferred resources to include in the resource candidate selection set based on one or more criteria. For example, the first UE may be configured to exclude non-preferred resources indicated by a destination UE and/or from the second UE, such as in embodiments where the destination UE and the second UE are different. Thus, if a resource is being used for communication between two different UEs, the first UE may include the resource in the resource candidate selection set. As another example, the criteria may comprise a reason for non-preference of the resources that is transmitted by the second UE along with set of non-preferred resources. For instance, the second UE may specify if the resources are non-preferred due to a conflict or due to second UE not performing listening for the resources, such as in half-duplex systems. The first UE may be configured to select non-preferred resource due to half-duplex over non-preferred resources due to known conflict.

In some embodiments, the first UE includes the non-preferred resources in the resource candidate selection set in response to one or more triggering conditions. For example, a triggering condition may comprise a determination by the first UE that a number of resources remaining for selection if the non-preferred resources are excluded from the resource candidate selection set is less than a threshold value, such as X*Mₜₒₜₐₗ where X is a preconfigured parameter that specifies the minimum percentage of the total resources that needs to be passed to the higher layer and Mₜₒₜₐₗ is the total number of resources within the resource selection window. Additionally or alternatively, the triggering condition may comprise a determination by the first UE that a number of non-preferred resources for a single slot comprises (1−X)*Mₜₒₜₐₗ or greater. In some embodiments, the first UE selects a number of non-preferred resources to include based on the threshold condition. For example, the first UE may select, from the non-preferred resources, a number of resources such that a number of remaining non-preferred is less than a threshold value of (1−X)*Mₜₒₜₐₗ.

In embodiments where the first UE includes a specific number and/or threshold number of non-preferred resources, such as in the example of the threshold described above, the first UE may be configured to select resources based on a first criterion. If the number of resources selected based on the first criterion is less than the specific number or threshold number of non-preferred resources, the first UE may be configured to select resources based on a second criterion. The first and second criteria may include any of the criteria described herein. For instance, the first UE may be configured to initially include non-preferred resources that are indicated as being reserved by other UEs followed by non-preferred resources that are indicated as being reserved by an assisting UE, followed by non-preferred resources that are indicated as being reserved by the second UE.

In some embodiments, the triggering condition comprises a determination by the first UE that inclusion of non-preferred resources has been enabled in resource pool configuration data. For example, resource pool configuration data may indicate whether inclusion of non-preferred resources is enabled and/or how exclusion of non-preferred resources is performed, such as assumption of reservation and/or selection based on criteria.

At step 306, the first UE selects a resource from the set of candidate resources for transmission. For example, the first UE performs a selection under Scheme 1 of a resource from the set of candidate resources and transmits data to another UE using the resource.

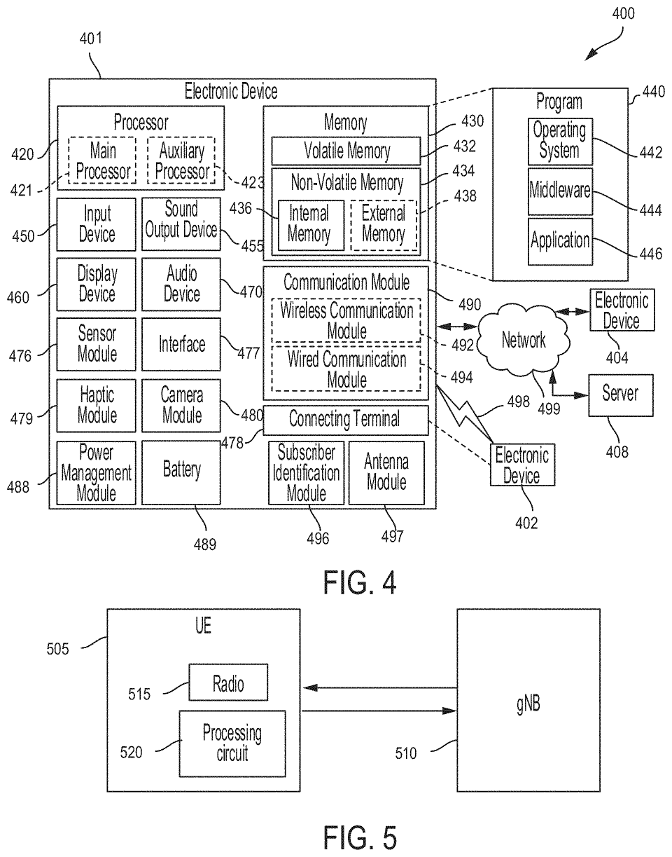

FIG. 4 is a block diagram of an electronic device in a network environment 400, according to an embodiment. The electronic device of FIG. 4 may comprise the Rx UE or Tx UE performing the functions described herein, such as the UEs of FIG. 1 and/or the UEs performing the operations of FIG. 2 or 3.

Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 430, an input device 450, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 494. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 476 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as Bluetooth™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

FIG. 5 shows a system including a UE 505 and a gNB 510, in communication with each other. The UE may include a radio 515 and a processing circuit (or a means for processing) 520, which may perform various methods disclosed herein, e.g., the method illustrated in FIG. 1. For example, the processing circuit 520 may receive, via the radio 515, transmissions from the network node (gNB) 510, and the processing circuit 520 may transmit, via the radio 515, signals to the gNB 510.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
receiving, at a first user equipment (UE) from a second UE, data identifying a periodic reservation of a resource;
determining, at the first UE, that there is a conflict for the resource in at least one instance of a plurality of instances of the periodic reservation of the resource; and
transmitting, from the first UE to the second UE, a PSFCH resource comprising a cyclic shift which indicates a strict subset of the plurality of instances of the periodic reservation that include the conflict for the resource.

2. The method of claim 1, wherein the strict subset of the plurality of instances consists of a first instance of the periodic reservation.

3. The method of claim 1, wherein the strict subset of the plurality of instances excludes a first instance of the periodic reservation.

4. The method of claim 3, wherein the strict subset of the plurality of instances consists of a single instance other than the first instance.

5. The method of claim 1, further comprising:
identifying, at the first UE, stored configuration data for a particular resource pool which indicates a type of information the first UE can provide and which cyclic shifts correspond to conflicts on different instances of the plurality of instances; and
determining the cyclic shift based on the stored configuration data.

6. The method of claim 1, wherein transmitting the PSFCH resource comprising the cyclic shift which indicates the strict subset of the plurality of instances of the periodic reservation that includes the conflict for the resource causes the second UE to select an alternative resource for the strict subset of the plurality of instances of the periodic reservation while maintaining the periodic reservation for one or more remaining instances of the periodic reservation.

7. A method comprising:
receiving, at a first user equipment (UE) from a second UE, resource selection assistance information which identifies a plurality of non-preferred resources;
generating a set of candidate resources comprising one or more of the non-preferred resources; and
selecting a resource from the set of candidate resources comprising the one or more of the non-preferred resources for transmission.

8. The method of claim 7, wherein generating the set of candidate resources comprises including the one or more of the non-preferred resources with an assumption that the one or more of the non-preferred resources are reserved by a neighboring UE.

9. The method of claim 8, wherein the assumption that the one or more of the non-preferred resources are reserved by a neighboring UE comprises a priority level for the assumed reservation that is pre-configured for a resource pool or type of transmission.

10. The method of claim 8, wherein the assumption that the one or more of the non-preferred resources are reserved by a neighboring UE comprises an RSRP level for the assumed reservation that is pre-configured for a resource pool or type of transmission.

11. The method of claim 7, wherein generating the set of candidate resources comprising the one or more of the non-preferred resources comprises selecting non-preferred resources for inclusion based on one or more criteria.

12. The method of claim 11, wherein the one or more criteria comprise whether the one or more of the non-preferred resources were indicated by a destination UE or the second UE from which assistance was requested.

13. The method of claim 11, wherein the one or more criteria comprise whether the one or more of the non-preferred resources are listed as non-preferred due to a conflict or due to the second UE not performing listening for the one or more of the non-preferred resources.

14. The method of claim 7, further comprising:
detecting, at the first UE, a triggering condition; and
including the one or more of the non-preferred resources in the set of candidate resources in response to detecting the triggering condition.

15. The method of claim 14, wherein the triggering condition comprises a determination that exclusion of all of the non-preferred resources would cause a remaining number of resources to be less than a threshold value or that a number of non-preferred resources is greater than a threshold value.

16. The method of claim 15, further comprising:
selecting one or more first resources from the non-preferred resources based on a first criterion; and
determining, that the triggering condition would still be satisfied if the one or more first resources are not excluded and, in response, selecting one or more second resources from the non-preferred resources based on a second criterion;
wherein the one or more of the non-preferred resources include the one or more first resources and the one or more second resources.

17. A method comprising:
detecting, at a first user equipment (UE), a triggering condition for resource selection assistance;
in response to detecting the triggering condition, determining whether a second condition is satisfied; and
transmitting, from the first UE to a second UE, resource selection assistance information in response to determining that the second condition is satisfied.

18. The method of claim 17, wherein the second condition comprises a channel busy ratio (CBR) being below a threshold value.

19. The method of claim 18, further comprising determining the threshold value based on a priority level of communications from the second UE.

20. The method of claim 17, wherein the second condition comprises a number of assistances reports received from neighboring UEs within a particular period of time being less than a threshold number.

21. The method of claim 17, wherein the first UE is configured to only determine that the second condition is satisfied prior to transmission of resource selection assistance information for groupcast or broadcast transmissions.

22. A system comprising:
a first user equipment (UE) configured to send resource selection assistance information to a second UE which identifies a plurality of non-preferred resources; and
the second UE configured to:
generate a set of candidate resources comprising one or more of the non-preferred resources; and
select a resource from the set of candidate resources comprising the one or more of the non-preferred resources for transmission.

23. The system of claim 22, wherein the first UE is configured to:
detect a triggering condition for resource selection assistance;
in response to detecting the triggering condition, determine whether a second condition is satisfied; and
transmit the resource selection assistance information in response to determining that the second condition is satisfied.

24. A system comprising:
a first user equipment (UE) configured to send data identifying a periodic reservation of a resource to a second UE; and
the second UE configured to:
determine that there is a conflict for the resource in at least one instance of a plurality of instances of the periodic reservation of the resource; and
transmit, to the first UE, a PSFCH resource comprising a cyclic shift which indicates a strict subset of the plurality of instances of the periodic reservation that include the conflict for the resource.
